(19) United States
(12) Patent Application Publication
(10) Pub. No.: US 2024/0114113 A1
(43) Pub. Date: Apr. 4, 2024

(54) MONITORING SYSTEM

(71) Applicant: DENSO WAVE INCORPORATED, Chita-gun (JP)

(72) Inventors: Marie MAEKAWA, Chita-gun (JP); Tatsuya HIRATA, Chita-gun (JP)

(73) Assignee: DENSO WAVE INCORPORATED, Chita-gun (JP)

(21) Appl. No.: 18/374,115

(22) Filed: Sep. 28, 2023

(30) Foreign Application Priority Data
Oct. 4, 2022 (JP) 2022-160322

(51) Int. Cl. H04N 7/18; G06F 21/44

(52) U.S. Cl. CPC H04N 7/18; G06F 21/44

(57) ABSTRACT

A monitoring system comprises a monitoring device, a terminal device that has an imaging function and transmits identification information, and the monitoring center. The monitoring device performs an authentication process of the terminal device based on the identification information received, and transmits first information that associates an authentication time, region information for specifying a monitoring region, and the identification information received. The terminal device transmits second information that associates an image in the monitoring region captured, a capture time of the image, and the identification information. The monitoring center associates, with the image of the second information, the authentication time and the region information of the first information that is associated with the same identification information as the identification information of the second information and is also associated with the authentication time in which a difference from the capture time of the second information is within a prescribed range.

### CROSS-REFERENCE TO RELATED APPLICATION

This application is based on and claims the benefit of priority from earlier Japanese Patent Application No. 2022-160322 filed Oct. 4, 2022, the description of which is incorporated herein by reference.

### BACKGROUND OF THE INVENTION

### Technical Field of the Invention

The present disclosure relates to a monitoring system.

### Related Art

There has been a system in which a security device (i.e., a monitoring device) monitors an unattended property, which a user has left, and reports from the monitoring device to a monitoring center at an occurrence of abnormality such as an intrusion into the property (for example, JP2017-157151A). Based on the report, a security guard (i.e., a worker) is dispatched to the property. The worker performs work for dealing with the abnormality that occurred in the property, or work requested by a manager of the property.

### SUMMARY

However, there is a possibility that malicious acts in a monitoring region by a worker working in the monitoring region may be suspected. For example, when work is performed on a monitoring device in a property where a resident is absent, there is a possibility that a resident may suspect malicious acts such as theft or damage to articles by a worker.

The present disclosure has been made in view of the above-described circumstances and has as its object to provide a monitoring system that can reduce suspicion of malicious acts in a monitoring region by a worker working in the monitoring region.

A monitoring system according to an embodiment of the present disclosure comprises a monitoring device that monitors a previously determined monitoring region and communicates with a terminal device and a monitoring center; the terminal device that has an imaging function, stores identification information of the terminal device, and communicates with the monitoring device and the monitoring center; and the monitoring center that communicates with the monitoring device and the terminal device. The terminal device transmits the identification information to the monitoring device. The monitoring device receives the identification information from the terminal device, performs an authentication process of the terminal device based on the identification information received, and transmits, to the monitoring center, first information that mutually associates an authentication time when the authentication process was performed, region information for specifying the monitoring region, and the identification information received. The terminal device transmits, to the monitoring center, second information that mutually associates an image in the monitoring region captured by the imaging function, a capture time of the image, and the identification information of the terminal device. The monitoring center associates, with at least the image of the second information, at least the authentication time and the region information of the first information that is associated with the same identification information as the identification information of the second information and is also associated with the authentication time in which a difference from the capture time of the second information is within a prescribed range.

### BRIEF DESCRIPTION OF THE DRAWINGS

In the accompanying drawings:

FIG. 1 is a diagram schematically illustrating an example of a configuration of a monitoring system according to an embodiment of the present disclosure:

FIG. 2 is a block diagram illustrating an example of a functional configuration of a monitoring system according to an embodiment of the present disclosure;

FIG. 3 is a diagram illustrating an example of first information acquired in a monitoring system according to an embodiment of the present disclosure;

FIG. 4 is a diagram illustrating an example of second information acquired in a monitoring system according to an embodiment of the present disclosure;

FIG. 5 is a diagram illustrating an example of related information based on first information and second information stored in a monitoring system according to an embodiment of the present disclosure;

FIG. 6 is a first part of a flowchart of a process performed by a monitoring system according to an embodiment of the present disclosure;

FIG. 7 is a second part of the flowchart of the process performed by a monitoring system according to an embodiment of the present disclosure;

FIG. 8 is a third part of the flowchart of the process performed by a monitoring system according to an embodiment of the present disclosure; and

FIG. 9 is a hardware configuration diagram of a monitoring system according to an embodiment of the present disclosure.

### DETAILED DESCRIPTION OF THE PREFERRED EMBODIMENTS

Hereinafter, embodiments will be described with reference to the drawings.

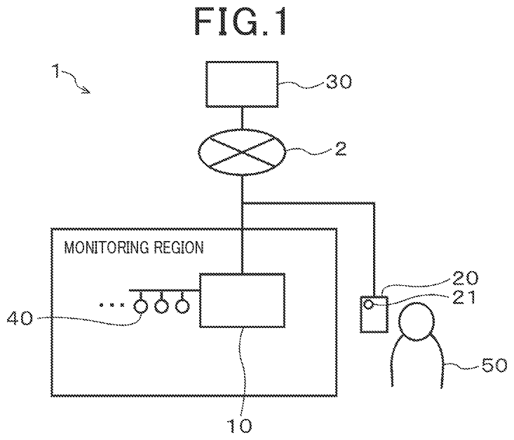

A monitoring system 1 illustrated in FIG. 1 monitors a building (i.e., a property) such as a house or an office as a monitoring region and detects and reports abnormalities in the building. The monitoring system 1 may be a so-called home security system. The monitoring system 1 includes a monitoring device 10, a terminal device 20 to be operated by a worker, a monitoring center 30, and an abnormality detection unit 40. The monitoring device 10 and the terminal device 20 are each communicably connected to the monitoring center 30 via a network 2 such as the Internet or telephone lines. The connection between the monitoring device 10 or the terminal device 20 and the network 2 may be implemented via a local area network (LAN). For example, the monitoring device 10 and the terminal device 20 may be connected to the network 2 via a wireless LAN through an unillustrated access point or the like. Also, the abnormality detection unit 40 is communicably connected to the monitoring device 10. The monitoring device 10 may be associated with a plurality of terminal devices 20 by storing identification information of the terminal devices 20.

The monitoring device 10 controls the operation of the abnormality detection unit 40. The abnormality detection unit 40 is installed in a building as a monitoring region and detects abnormalities in the building. Examples of the abnormality detection unit 40 may include a sensor to detect the opening and closing of a window, an InfraRed (IR) sensor to detect a human body, and a sensor to detect fire or smoke, or the like. The monitoring device 10 controls the operation and non-operation of the abnormality detection unit 40 to switch between the operation and non-operation of the monitoring system 1. In response to the detection of abnormality in a building by the detection unit 40, the monitoring device 10 transmits an abnormality signal to the monitoring center 30.

The monitoring system 1 may be provided with, for example, an alert mode and a release mode as a monitoring mode for a building. The alert mode is a mode in which the abnormality detection unit 40 operates and performs monitoring in a building. On the other hand, the release mode is a mode in which the abnormality detection unit 40 is switched to non-operation and does not perform monitoring in a building. It is noted that the release mode may be a mode in which while the abnormality detection unit 40 operates, the monitoring device 10 does not transmit an abnormality signal to the monitoring center 30 even when abnormality is detected.

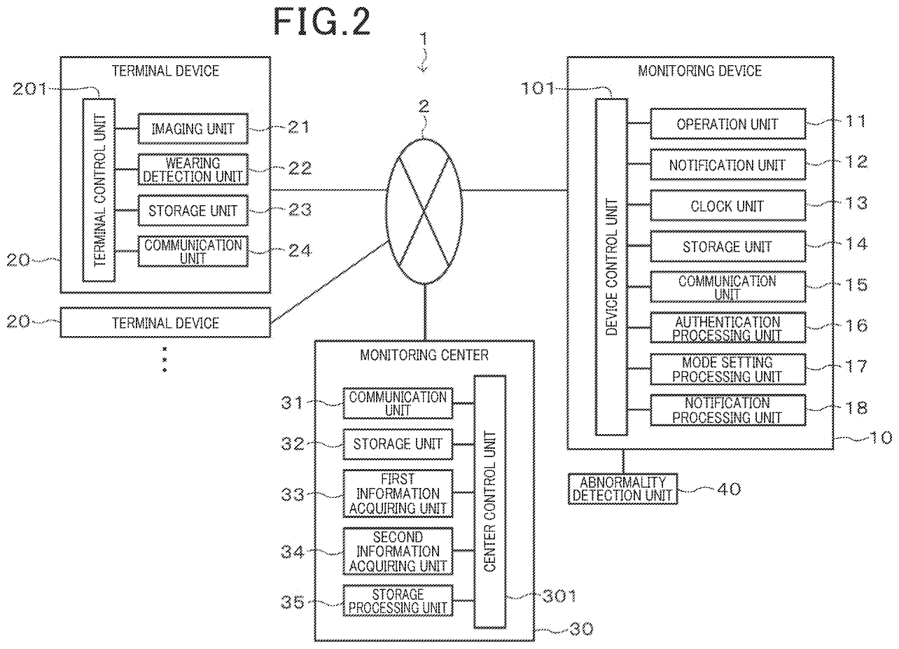

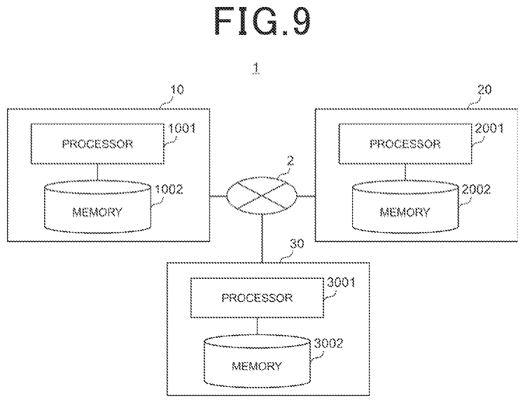

As illustrated in FIG. 2, the monitoring device 10 includes a device control unit 101, an operation unit 11, a notification unit 12, a clock unit 13, a storage unit 14, and a communication unit 15. The device control unit 101 controls the entirety of the monitoring device 10. The device control unit 101 may be realized by, for example, as illustrated in FIG. 9, a processor 1001 such as a central processing unit (CPU) and a memory 1002 such as a read only memory (ROM), a random access memory (RAM), and a flash memory. For example, the device control unit 101 may be realized by a microcomputer having the processor 1001 and the memory 1002. The operation unit 11, the notification unit 12, the clock unit 13, the storage unit 14, and the communication unit 15 are each connected to the device control unit 101. The electric power necessary for the operation of the monitoring device 10 is supplied from, for example, an unillustrated battery integrated inside the monitoring device 10.

The operation unit 11 accepts an input operation of a worker 50. The operation unit 11 may be realized by, for example, a touch panel or an operation button. The notification unit 12 notifies information necessary for the worker 50. The notification unit 12 may be realized by, for example, a display or a speaker. The notification unit 12 may notify the contents of the input operation to the operation unit 11. The notification unit 12 may be implemented integrally with the operation unit 11. The clock unit 13 acquires a time. The time may be a time point, and may be expressed by, for example, date, hour, minute, and second. The clock unit 13 may also have the function of measuring a time elapsed from a point of time to serve as a reference. The time may denote the length in time from a certain time point to another time point.

The storage unit 14 may be realized by, for example, a semiconductor memory such as a ROM or a magnetic disk such as a hard disk drive (HDD). The storage unit 14 stores, for example, property information and position information as specification information of a building. The specification information (i.e., region information) is information for specifying a monitoring region to be monitored by the monitoring device 10 (for example, a building having the monitoring device 10 installed or a part of the building). The property information is, for example, an identification number assigned to a building having the monitoring device 10 installed. The identification number is expressed by a combination of numbers, letters, signs, and others. The position information is information indicating the position of a building having the monitoring device 10 installed. The position information is, for example, information indicating the address of a building or the latitude and longitude where a building is positioned. The communication unit 15 is an interface for communicating with the terminal device 20 and the monitoring center 30. The communication unit 15 has, for example, a short-distance wireless communication function such as a Bluetooth (registered trademark) to communicate with the terminal device 20. Also, the communication unit 15 includes, for example, a wired communication function capable of communicating with the network 2 to communicate with the monitoring center 30.

The terminal device 20 may be an information communication terminal device (for example, a smartphone) that can be carried by the worker 50. The terminal device 20 may be a terminal device (for example, a wearable terminal device) that can be worn by the worker 50. In this case, the terminal device 20 may be integrated with clothes worn by the worker 50 or may be a terminal device that can be worn to the head of a glasses type terminal device. The terminal device 20 includes a terminal control unit 201, a imaging unit 21, a wearing detection unit 22, a storage unit 23, and a communication unit 24. The terminal device 20 may include the above-described clock unit (not illustrated). The terminal control unit 201 controls the entirety of the terminal device 20. The terminal control unit 201 may be realized by, for example, as illustrated in FIG. 9, a processor 2001 such as a CPU and a memory 2002 such as a ROM, a RAM, and a flash memory. For example, the terminal control unit 201 may be realized by a microcomputer having the processor 2001 and the memory 2002.

The imaging unit 21 captures an image (for example, a still image or a video). The imaging unit 21 may be realized by, for example, an omnidirectional camera (i.e., a 360-degree camera) capable of capturing an image of 360-degree surroundings. The imaging unit 21 may be integrated with components other than the imaging unit 21 in the terminal device 20 or may be separated from the other components and connected thereto via wiring or the like. In the present embodiment, the imaging unit 21 is integrated with the terminal device 20. When the imaging unit 21 is integrated with the other components than the imaging unit 21 in the terminal device 20 in this manner, for example, the worker 50 can be prevented from leaving the imaging unit 21 and heading for a building with only the terminal device 20 carried.

The wearing detection unit 22 detects the wearing state of the imaging unit 21 of the worker 50. When the imaging unit 21 is integrated with the terminal device 20, it can also be said that the wearing detection unit 22 detects the wearing state of the terminal device 20. The terminal device 20 uses a signal output from the wearing detection unit 22 to detect whether the imaging unit 21 is worn by the worker 50. The wearing detection unit 22 may be realized by, for example, an acceleration sensor, a gyroscope sensor, or a biosensor. For example, the terminal control unit 201 determines that the imaging unit 21 is not worn by the worker 50 when a detection signal is not received by the wearing detection unit 22 for a prescribed period (for example, about several seconds to several minutes). The terminal control unit 201 can determine that work is performed without the imaging unit 21 worn by the worker 50, based on other information (for example, information indicating working) and a detection signal. In brief, the terminal control unit 201 can determine that a work location is not captured by the imaging unit 21. Also, the terminal device 20 provides a detection signal of the wearing detection unit 22 to the monitoring device 10 through the communication unit 24.

The storage unit 23 stores various pieces of information. The storage unit 23 may be realized by, for example, a semiconductor memory such as a ROM or a magnetic disk such as an HDD. It is noted that the terminal device 20 may include a radio frequency (RF) tag. The storage unit 23 can store, for example, identification information of the terminal device 20. The identification information of the terminal device 20 is, for example, an identification number assigned for identifying the terminal device 20. The identification information is used for identifying the terminal device 20 when the monitoring device 10 authenticates the terminal device 20. In authenticating the terminal device 20, it is determined if the terminal device 20 to be authenticated is a previously registered authorized terminal device 20. The storage unit 14 of the monitoring device 10 stores identification information of a plurality of terminal devices 20. Also, authentication performed by the monitoring device 10 contains authentication for releasing the alert mode. In brief, the identification information may be used for authentication for switching the monitoring mode of the monitoring device 10. It is noted that the authentication for releasing the alert mode may be performed using an authentication apparatus separated from the terminal device 20.

The storage unit 23 further stores a video captured by the imaging unit 21 and the time (i.e., capture time) when the video was captured. The identification information of a video may be stored as video information. The capture time may contain the date and the time when the imaging unit 21 started capturing video and the time when it stopped capturing the video. The capture time may be measured in seconds. The communication unit 24 is an interface for communicating with the monitoring device 10 and the monitoring center 30. The communication unit 24 has, for example, a short-distance wireless communication function similarly to the communication unit 15 to communicate with the monitoring device 10. Also, the communication unit 24 includes, for example, a wireless communication function capable of communicating with the network 2 to communicate with the monitoring center 30.

Also, the monitoring device 10 includes an authentication processing unit 16, a mode setting processing unit 17, and a notification processing unit 18. The authentication processing unit 16, the mode setting processing unit 17, and the notification processing unit 18 may be realized by, for example, the processor 1001 executing a computer program stored in the memory 1002 of the monitoring device 10. Also, some or all of the authentication processing unit 16, the mode setting processing unit 17, and the notification processing unit 18 may be disposed to the terminal device 20 or the monitoring center 30.

The authentication processing unit 16 executes an authentication process. The authentication process contains a process of performing authentication of the terminal device 20 by identification information acquired from the terminal device 20 through the communication unit 15. The authentication process is performed when, for example, the worker 50 switches the monitoring mode of the monitoring system 1 from the alert mode to the release mode. The authentication processing unit 16 checks identification information acquired from the terminal device 20 against identification information of the terminal device 20 stored in the monitoring device 10. When these pieces of identification information match, authentication is a success. Also, the storage unit 14 stores the time (i.e., the authentication time) when an authentication process was performed by the authentication processing unit 16.

The mode setting processing unit 17 executes a mode setting process. The mode setting process contains a process of setting the monitoring mode of the monitoring system 1 to one of the alert mode and the release mode based on the result of the authentication process or the operation to the operation unit 11. The mode setting processing unit 17 switches from the alert mode to the release mode in response to, for example, authentication of the terminal device 20 during the alert mode. On the other hand, the mode setting processing unit 17 switches from the release mode to the alert mode in response to, for example, the operation to the operation unit 11 by the worker 50 to set to the alert mode during the release mode.

The notification processing unit 18 executes a notification process. The notification process contains a process of performing notification to the worker 50 in response to the wearing detection unit 22 detecting the state in which the imaging unit 21 is not worn by the worker 50. That is, the notification processing unit 18 performs notification in response to receipt of a detection signal from the terminal device 20. The notification processing unit 18 uses the notification unit 12 to notify the worker 50 that the imaging unit 21 is not worn. Also, the notification process may contain a process of determining that a work location is not captured by the imaging unit 21 based on a detection signal received from the terminal device 20 and the above-described other information.

The monitoring center 30 is installed in a position different from the monitoring region. For example, the monitoring center 30 may be installed in a facility managed by a security company. The monitoring center 30 performs a process related to, for example, the dispatch of the worker 50 to a building monitored by the monitoring device 10, in response to receipt of an abnormality signal transmitted from the monitoring device 10. The worker 50 may be dispatched for performing work (e.g., cleaning) requested by a manager of the building monitored, instead of work related to the described above abnormality signal. The monitoring center 30 includes a center control unit 301, a communication unit 31, a storage unit 32, a first information acquiring unit 33, a second information acquiring unit 34, and a storage processing unit 35. The center control unit 301 controls the entirety of the monitoring center 30. The communication unit 31 is an interface to perform communication via the network 2. The storage unit 32 may be realized by, for example, a semiconductor memory such as a ROM or a magnetic disk such as an HDD. The storage unit 32 stores specification information of a building, identification information of a plurality of terminal devices 20, and others.

The first information acquiring unit 33, the second information acquiring unit 34, and the storage processing unit 35 are realized by, for example, as illustrated in FIG. 9, a processor 3001 executing a computer program stored in a memory 3002 of the monitoring center 30. Also, some or all of the first information acquiring unit 33, the second information acquiring unit 34, and the storage processing unit 35 may be disposed to the monitoring device 10 or the terminal device 20.

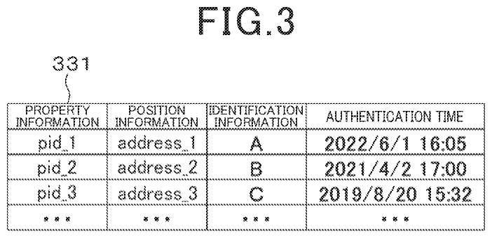

The first information acquiring unit 33 acquires first information 331. The first information 331 contains information regarding authentication of the terminal device 20. The first information 331 is, as illustrated in FIG. 3, information that mutually associates the authentication time when the terminal device 20 was authenticated by the monitoring device 10, the specification information of a building to have the monitoring device 10 installed, and the identification information of the terminal device 20 authenticated by the monitoring device 10. In brief, the first information 331 indicates that the terminal device 20 existed in the monitoring region at the authentication time. That is, from the first information 331, there can be identified a building to which the worker 50 carrying the terminal device 20 was dispatched.

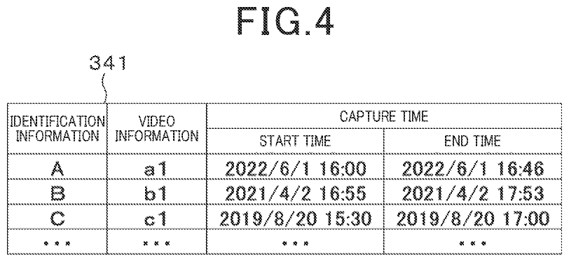

The second information acquiring unit 34 acquires second information 341. The second information 341 contains information acquired by the capturing of a video by the imaging unit 21. The second information 341 is, as illustrated in FIG. 4, information that mutually associates video information, a capture time, and identification information of the terminal device 20 including the imaging unit 21 that captured the video. That is, from the second information 341, there can be identified the terminal device 20 including the imaging unit 21 that captured video and the time when the video was captured.

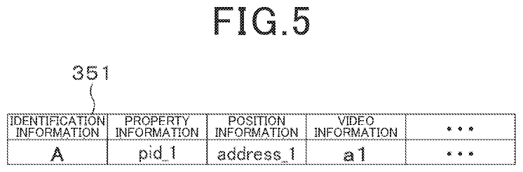

The storage processing unit 35 performs a storage process. The storage process contains a process of storing, in the storage unit 32, the first information 331 and the second information 341 acquired by the first information acquiring unit 33 and the second information acquiring unit 34. In the present embodiment, the storage processing unit 35 associates, with the second information 341, the first information 331 that is associated with the same identification information as the identification information of the second information 341 and is also associated with the authentication time in which a difference from the capture time of the second information 341 is within a prescribed range. As illustrated in FIG. 5, the storage processing unit 35 stores, in the storage unit 32, information contained in the first information 331 and the second information 341 associated with each other, as associating information 351.

The associating information 351 is information contained in the first information 331 and the second information 341 associated with each other. The associating information 351 contains, for example, the identification information of the terminal device 20, the specification information of a building, and the video information. The associating information 351 associates the authentication time of the terminal device 20 with the video indicated by the video information contained in the associating information 351. In brief, the associating information 351 can be used to indicate that the associated video was captured by the authenticated terminal device 20. Alternatively, individual pieces of information contained in the first information 331 and the second information 341 may be separately stored in the storage unit 32 as the first information 331 and the second information 341, and association of the first information 331 and the second information 341 may be stored in the storage unit 32 as the associating information 351.

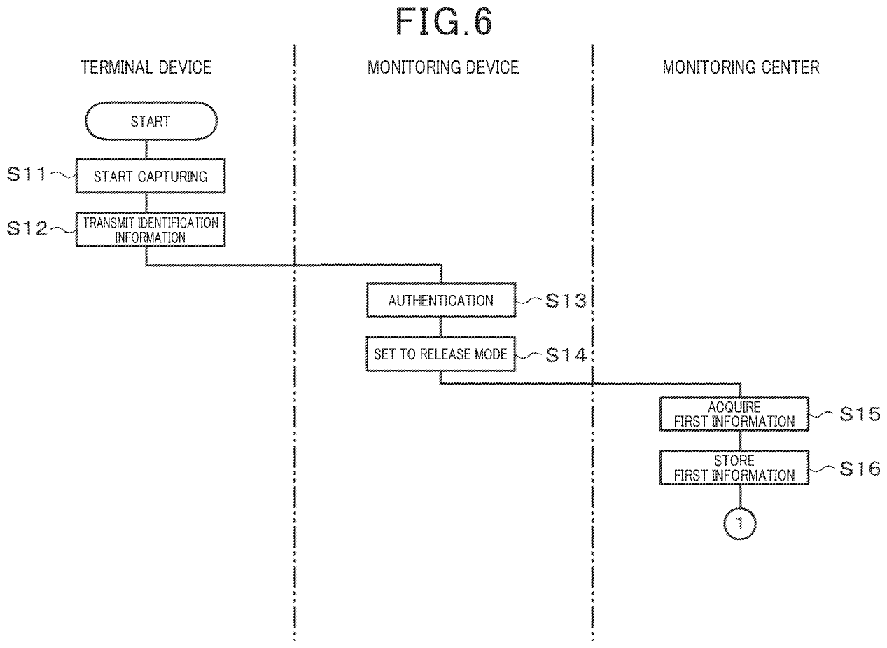

Next, with additional reference to FIG. 6 to FIG. 8, a process performed in the monitoring system 1 will be described. Here, it is assumed that in the alert mode, the monitoring center 30 received an abnormality signal from the monitoring device 10, and the worker 50 was dispatched to a building having the monitoring device 10 installed.

First, the process will be described with reference to FIG. 6. The worker 50 arrives at a building and unlocks a door of the building to enter the building. In step S11, the terminal device 20 starts capturing video in response to receipt of an operation to start capturing by the worker 50. In case where the terminal device 20 comprises a clock unit, the terminal device 20 acquires a capture start time (i.e., a capture time) using the clock unit. Next, in step S12, the terminal device 20 transmits identification information to the monitoring device 10 through wireless communication. Then, the monitoring device 10 performs, in step S13, authentication of the terminal device 20 based on the received identification information. It is noted that the terminal device 20 may start capturing video in response to the authentication process in the monitoring device 10. For example, the terminal device 20 may start capturing video in response to transmitting the identification information to the monitoring device 10 or receiving an authentication result from the monitoring device 10. The authentication result may be an availability of authentication or an authentication time. Also, in case where the terminal device 20 comprises no clock unit, the terminal device 20 may receive the authentication time from the monitoring device 10 to acquire the authentication time as the capture start time.

Next, the monitoring device 10 sets, in step S14, the monitoring mode of the monitoring system 1 to the release mode. In other words, the monitoring device 10 switches from the alert mode to the release mode. In response to the switching of the monitoring mode of the monitoring system 1 to the release mode, the monitoring center 30 acquires, in step S15, the first information 331 from the monitoring device 10. Then, in step S16, the monitoring center 30 stores the first information 331 in the storage unit 32.

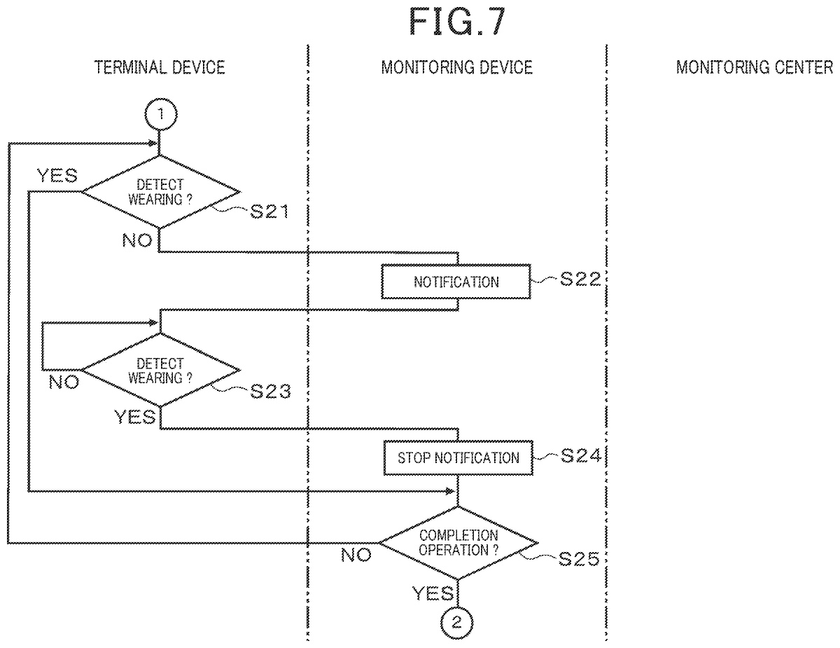

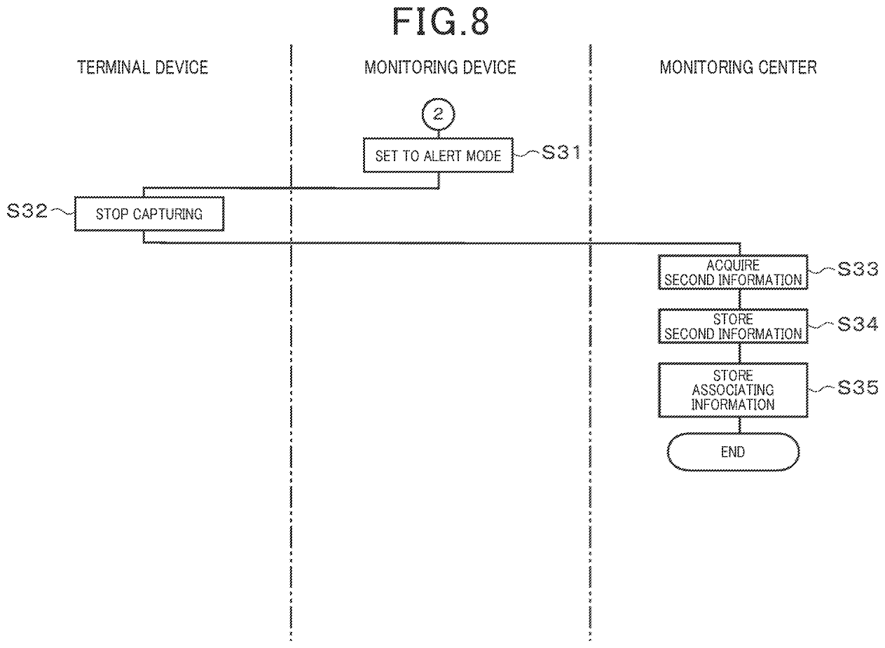

Next, the process will be described with reference to FIG. 7 and FIG. 8. In response to completion of the authentication of the terminal device 20, the terminal device 20 uses, in step S21, the wearing detection unit 22 to determine whether the imaging unit 21 is worn by the worker 50. When it is determined in the terminal device 20 that the imaging unit 21 is worn by the worker 50, the process moves to step S25. Then, the monitoring device 10 determines, in step S25, whether the worker 50 performed an operation to indicate the completion of work to the operation unit 11.

When the operation to indicate the completion of work is not performed (NO in step S25), the monitoring device 10 returns the process to the step S21. On the other hand, when the operation to indicate the completion of work was performed (YES in step S25), the monitoring device 10 moves the process to step S31 in FIG. 8. In step S31, the monitoring device 10 sets the monitoring mode of the monitoring system 1 to the alert mode. Then, the terminal device 20 stops, in step S32, capturing video in response to receipt of an operation to stop the capturing of the imaging unit 21 by the worker 50. In case where the terminal device 20 comprises a clock unit, the terminal device 20 acquires a capture stop time (i.e., a capture time) using the clock unit. It is noted that the terminal device 20 may stop capturing video in response to a re-authentication process in the monitoring device 10. For example, the terminal device 20 may stop capturing video in response to, during capturing video, transmitting the identification information to the monitoring device 10 or receiving a re-authentication result from the monitoring device 10. Also, in case where the terminal device 20 comprises no clock unit, the terminal device 20 may receive a re-authentication time to acquire the re-authentication time as a capture stop time.

Next, the monitoring center 30 acquires, in step S33, the second information 341 from the terminal device 20. Then, in step S34, the monitoring center 30 stores the second information 341 in the storage unit 32. Thereafter, the monitoring center 30 stores, in step S35, the associating information 351 that mutually associates the first information 331 and the second information 341 in the storage unit 32. Then, the process of the monitoring system 1 ends. It is noted that the second information 341 may be transmitted from the terminal device 20 to the monitoring center 30 via the monitoring device 10.

Description will be continued by returning to FIG. 7. When it is determined in the terminal device 20 that the imaging unit 21 is not worn by the worker 50 (NO in step S21), the process moves to step S22. In step S22, the monitoring device 10 uses the notification unit 12 to notify the worker 50 that the imaging unit 21 is not worn, in response to receipt of a detection signal (i.e., information indicating that the imaging unit 21 is not worn by the worker 50) from the terminal device 20. The terminal device 20 determines, in step S23, whether the imaging unit 21 has been worn by the worker 50. When it was determined in the terminal device 20 that the imaging unit 21 is worn by the worker 50 (YES in step S23), the process moves to step S24.

In step S24, the monitoring device 10 stops the notification by the notification unit 12 in response to receipt from the terminal device 20 of information indicating that the imaging unit 21 has been worn. Then, the monitoring device 10 moves the process to step S25.

According to the above-described present embodiment, the monitoring system 1 includes a monitoring device 10, a terminal device 20, a first information acquiring unit 33, and a second information acquiring unit 34. The monitoring device 10 is installed in a previously determined monitoring region. The terminal device 20 includes a imaging unit 21 and a storage unit 23. The imaging unit 21 captures video. The storage unit 23 stores information. The terminal device 20 stores, in the storage unit 23, identification information for identifying the individual of the terminal device 20 when the monitoring device 10 performs authentication. The first information acquiring unit 33 acquires first information 331. The first information 331 mutually associates the authentication time regarding the time when the monitoring device 10 authenticated the terminal device 20, the specification information for specifying a monitoring region disposed with the monitoring device 10, and the identification information of the terminal device 20 authenticated by the monitoring device 10. Then, the second information acquiring unit 34 acquires second information 341. The second information 341 mutually associates the video information regarding a video captured by the imaging unit 21, the capture time regarding the time when the video was captured, and the identification information of the terminal device 20 including the imaging unit 21 that captured the video.

In other words, A monitoring system 1 according to an embodiment of the present disclosure comprises a monitoring device 10 that monitors a previously determined monitoring region and communicates with a terminal device 20 and a monitoring center 30, the terminal device 20 that has an imaging function, stores identification information of the terminal device 20, and communicates with the monitoring device 10 and the monitoring center 30, and the monitoring center 30 that communicates with the monitoring device 10 and the terminal device 20. The terminal device 20 transmits the identification information to the monitoring device 10. The monitoring device 10 receives the identification information from the terminal device 20, performs an authentication process of the terminal device 20 based on the identification information received, and transmits, to the monitoring center 30, first information 331 that mutually associates an authentication time when the authentication process was performed, region information for specifying the monitoring region, and the identification information received. The terminal device 20 transmits, to the monitoring center 30, second information 341 that mutually associates an image in the monitoring region captured by the imaging function, a capture time of the image, and the identification information of the terminal device 20. The monitoring center 30 associates, with at least the image of the second information 341, at least the authentication time and the region information of the first information 331 that is associated with the same identification information as the identification information of the second information 341 and is also associated with the authentication time in which a difference from the capture time of the second information 341 is within a prescribed range.

In this manner, the first information 331 associates, with each other, the authentication time of the terminal device 20 by the monitoring device 10 and the monitoring region. The second information 341 associates the capture time of the terminal device 20. Then, there is specified the first information 331 that is associated with the same identification information as the identification information of the terminal device 20 of the second information 341 and is also associated with the authentication time in which a difference from the capture time of the second information 341 is within a prescribed range. This can specify the image in the monitoring region captured by the authenticated terminal device 20 at a time within a predetermined range from the authentication time. In brief, it is indicated that an image captured by the imaging unit 21 was captured in a building having the monitoring device 10 installed that authenticated the terminal device 20 while the terminal device 20 was positioned in the building. Therefore, the image can be dealt with as an image in a monitoring region when the worker 50 carrying the terminal device 20 worked in the monitoring region. Thus, confirmation of the above-described image can reduce suspicion of malicious acts in the monitoring region by the worker 50 working in the monitoring region. For example, it can be demonstrated to a resident that the theft or damage of articles does not occur during work performed while the resident is absent.

That is, the use of the first information 331 and the second information 341 can prove to some extent, for example, that the theft or damage of articles did not occur during work performed while a resident was absent. Furthermore, when the terminal device 20 is a mobile terminal, the facility cost can be reduced compared to when the terminal device 20 is, for example, a monitoring camera installed in a building. In other words, the suspicion of malicious acts in the monitoring region by the worker 50 can be reduced at low cost. For example, the validity of work while a resident is absent can be proven to some extent.

The monitoring system 1 further includes a storage processing unit 35. The storage processing unit 35 associates, with the second information 341, the first information 331 that contains the same identification information as the identification information of the second information 341 and also contains the authentication time in which a difference from the capture time is within a prescribed range and stores the associating information 351. This allows the use of the associating information 351 to specify the video in the monitoring region captured by the terminal device 20 authenticated afterward. Furthermore, the associating information 351 may contain at least some of the first information 331 and the second information 341. In this case, the management of the associated information can be unified. This facilitates handling of the information for proving the validity of work while a resident is absent.

The monitoring system 1 also includes a wearing detection unit 22 and a notification processing unit 18. The wearing detection unit 22 detects whether the imaging unit 21 is worn by the worker 50. The notification processing unit 18 causes the notification unit 12 to notify the worker 50 of an alert when the wearing detection unit 22 does not detect that the imaging unit 21 is worn by the worker 50. This allows the worker 50 to notice that the imaging unit 21 is not worn. That is, the worker 50 can wear the imaging unit 21 in response to receipt of notification of the alert. This can prevent an image in the monitoring region from not being captured during work.

It is noted that an embodiment of the present disclosure has been described above. However, it is understood that the present disclosure is not limited to the above-described embodiment. The present disclosure can be variously modified without departing from the gist of the present disclosure.

1. A monitoring system comprising:
a monitoring device that monitors a previously determined monitoring region and communicates with a terminal device and a monitoring center;
the terminal device that has an imaging function, stores identification information of the terminal device, and communicates with the monitoring device and the monitoring center; and
the monitoring center that communicates with the monitoring device and the terminal device, wherein
the terminal device transmits the identification information to the monitoring device,
the monitoring device receives the identification information from the terminal device, performs an authentication process of the terminal device based on the identification information received, and transmits, to the monitoring center, first information that mutually associates an authentication time when the authentication process was performed, region information for specifying the monitoring region, and the identification information received,
the terminal device transmits, to the monitoring center, second information that mutually associates an image in the monitoring region captured by the imaging function, a capture time of the image, and the identification information of the terminal device, and
the monitoring center associates, with at least the image of the second information, at least the authentication time and the region information of the first information that is associated with the same identification information as the identification information of the second information and is also associated with the authentication time in which a difference from the capture time of the second information is within a prescribed range.

2. The monitoring system according to claim 1,
wherein the monitoring center stores associating information of at least the authentication time and the region information of the first information and at least the image of the second information.

3. The monitoring system according to claim 1, wherein
the terminal device is wearable by a user of the terminal device in at least a portion corresponding to the imaging function and detects whether the portion corresponding to the imaging function is worn by the user, and
the terminal device outputs an alert in response to it not detected that the portion corresponding to the imaging function is worn.

4. The monitoring system according to claim 1, wherein
the terminal device is wearable by a user of the terminal device in at least a portion corresponding to the imaging function and detects whether the portion corresponding to the imaging function is worn by the user,
the terminal device transmits, to the monitoring device, a detection result on whether the portion corresponding to the imaging function is worn by the user, and
the monitoring device outputs an alert in response to it not detected that the portion corresponding to the imaging function is worn.
